(19) United States
(12) Patent Application Publication
(10) Pub. No.: US 2006/0231625 A1
(43) Pub. Date: Oct. 19, 2006

(54) Security label which is optically read by terahertz radiation

(76) Inventors: David R. Cumming, Glasgow (GB); Timothy D. Drysdale, Glasgow (GB)

Correspondence Address: NIXON & VANDERHYE, PC, 901 NORTH GLEBE ROAD, 11TH FLOOR, ARLINGTON, VA, 22203, US

(21) Appl. No.: 10/548,529

(22) PCT Filed: Mar. 12, 2004
(86) PCT No.: PCT/GB04/01074

§ 371 Date: Apr. 14, 2006

(30) Foreign Application Priority Data
Mar. 12, 2003 (GB) V0305606.6

(51) Int. Cl. G06K 7/10; G06K 19/06

(52) U.S. Cl. 235/454; 235/491

(57) ABSTRACT

The present invention relates to security label (12) for securing or authenticating goods or services or a security document. Currently radio frequency ID cards, having an inductive loop and a microchip containing security information, are used. However, such RF ID cards are expensive to manufacture. Therefore it is proposed to use a security label or document (12) including a terahertz image or tag (14, 15, 76) which may beta hologram. Security information can then be read by reflection or transmission of terahertz radiation which is not visible to the unaided eye. The terahertz image or tag may be covered by a material (66, 68) opaque to visible light, but transparent or transmissive of terahertz wavelengths, making it difficult for potential fraudsters to investigate the terahertz image. A method of making such a security label or document, a security or authentication method and system using terahertz radiation are also disclosed.

### TECHNICAL FIELD

The present invention relates to a security label for securing or authenticating goods or services. The invention also relates to a method for producing such a security label and a method for reading it.

### BACKGROUND OF THE INVENTION

Covert security labels and tags are needed for many applications. Ideally, these should be difficult for unauthorised persons to detect, impossible to copy, and able to provide evidence of tampering. Also, it would be useful for such labels to be readable by readily available methods. This combination of properties is essential to a variety of potential government, military, and civilian covert security and covert tracking applications.

At present, one solution is the so-called radio-frequency identity (RF ID) card. This type of card or tag includes an inductive loop around its edges. Within and connected to the inductive loop is a microchip that includes security information. When the card is exposed to RF radiation, a current is induced in the loop. This causes sufficient current to be generated in the microchip to power it up and transmit secure data to an RF reader. In this way, data that is inaccessible without an RF reader can be transmitted to an authorised user. An advantage of these cards is that the microchip can be used to store a reasonable amount of information. However, whilst these RF ID cards are relatively secure, they are expensive to make, which prevents their use from being widespread.

### SUMMARY OF THE INVENTION

An object of the present invention is to provide a security label or tag that is simple and relatively tamper resistant.

According to one aspect of the present invention, there is provided a security label in which a terahertz image or tag is defined or embedded. By terahertz image or tag it is meant an image or tag that can only be viewed using radiation that has a frequency in the range of 25 GHz-100 THz. Preferably, the radiation used to read the image is in the range of 100 GHz-100 THz, and ideally around 500 GHz.

Preferably, the image is defined in or covered by a material that is opaque to visible light. Here the term “opaque” is defined to mean opaque to visible wavelengths, but transparent to, or transmissive of, terahertz wavelengths. This means that the image cannot be seen by the unaided eye. This provides an immediate barrier to potential fraudsters. As a specific example, the image may be covered with a dielectric material that is opaque. In order to render an otherwise transparent polymer opaque, dyes may be introduced or one or both surfaces may be patterned with random roughness, akin to frosted glass, or gratings with features in x, y, z axes of such a size that visible light is scattered, but terahertz radiation is transmitted. Since visible wavelengths are much smaller than terahertz wavelengths, these surface features are on the scale of microns. Since they would be much smaller than the tag features, they would not affect the ability of the terahertz imaging system to read the label.

The terahertz image may comprise one or more frequency selective surfaces that produce a resonant characteristic that can be detected by a scanner. The frequency selective surface may contain fractal patterns with structures on one or more length scales so that the structure is resonant at one or more wavelengths.

The terahertz image may comprise one or more holograms. These may be sensitive to one or more frequencies and, according to the depth to which the hologram is patterned, may contain one or more images corresponding to different stimulus frequencies.

Additionally or alternatively, the terahertz image may be defined using wires, punched foil or any other metallic or dielectric medium that can be patterned to provide an image forming contrast.

The terahertz image may be formed in any suitable material such as polycarbonate, polymethylmethacrylate, polystyrene, epoxy, polyethylene, Teflon, nylon, polyvinylchloride, polyaniline, poly(3,4-ethylenedioxythiophene, alkyd resins, phenolic, polaymide, polyanhydride, polyimide, polyurethane, resorcinol, silicone and urea resins or any mouldable plastic capable of taking an imprint or embossment.

The label may be suitable for broadband (e.g. containing many wavelengths) or narrowband (only one or very narrow range of wavelengths) illumination. As such, the label could be used to form a terahertz watermark.

Preferably the label is laminated. The terahertz image or tag may be formed or defined in one of the layers of the label. The layers of the label may comprise paper and/or plastic. An embedded layer of paper or plastic may have a terahertz readable pattern printed onto it using conductive ink. The label may be flexible. The label may be rigid. The label may have the same shape as a credit card.

Information may be embedded as (a) amplitude modifying (grey scale or black and white) or (b) phase modifying (diffractive optic or hologram). The information could be plain text or encoded.

The terahertz image or tag may be designed to operate in either a transmission mode or a reflection mode.

According to another aspect of the invention, there is provided a method for making a security label comprising embedding or encasing a terahertz image within a main body portion.

The method may further involve forming the terahertz image. The image may be defined by patterning any suitable substrate, for example a ceramic or semiconductor substrate such as silicon or any mouldable material, such as a mouldable plastic. This may be done using hot-embossing techniques or by etching, for example dry etching, such as reactive ion etching (RIE).

When hot embossing is used, preferably the terahertz image is defined in a mouldable plastic material such as any one or more of polycarbonate, polymethylmethacrylate, polystyrene, epoxy, polyethylene, Teflon, nylon, polyvinylchloride, polyaniline, poly(3,4-ethylenedioxythiophene), alkyd resins, phenolic, polamide, polyanhydride, polyimide, polyurethane, resorcinol, silicone and urea thermosetting resins. These materials may be opaque either in their basic form, or made opaque by incorporation of a dye.

When etching is used, the terahertz image may be defined in any suitable ceramic or semiconductor substrate. For example, the image may be defined in a silicon substrate. An advantage of this is that processing techniques for silicon are well known and in widespread use. In addition, when thin enough silicon can form a flexible layer. For use in security labels, this is a useful feature.

Where the image is a reflection mode image, the method may further involve coating the patterned substrate with a reflective material, such as metal. Of course the coating should be such as to substantially retain the relief pattern defined in the substrate. Metal may be deposited by a number of methods such as evaporation, sputter coating, electro-plating and electroless plating. Nickel, zinc and gold are examples of metals that could be used. Alternatively, spray painting or aerosol techniques may be used with or without a stencil or template.

Further methods for making the terahertz image include the use of techniques developed for patterning organic electronics. For example, the high-resolution, high-throughput, thermal imaging technique for dry-printing planar layers of conducting polymers as described in the paper: G. B. Blanchet, Y.-L. Loo, J. A. Rogers, F. Gao and C. R. Fincher, “Large area, high resolution, dry printing of conducting polymers for organic electronics,” Applied Physics Letters, Vol. 82, No. 3, p. 463, 20 Jan. 2003. This method could be used to pattern a planar layer of conductive material directly, in order to make an amplitude-contrast image or frequency-selective surface. It could equally be used to pattern a binary hologram for reflection or transmission mode, or even a multilevel hologram if multiple printing steps are employed. For a reflection mode hologram, the metal coating would be applied after printing, or may optionally be omitted if the printed polymer and the supporting substrate are conductive and sufficiently thick. For a transmission mode hologram, a lower conductivity polymer is preferred to improve transmission efficiency. In all cases the pattern may be laminated into the label.

Alternatively or additionally, the terahertz image may be formed by printing. The image may be formed by knitting or weaving using a combination of conductive, for example metallic, and non-conductive, for example non-metallic, fibres.

Where the image is a reflection mode image, it could be defined by any three-dimensional pattern made using a conductive material. For example, the pattern may be a metallic pattern and may be made using printing techniques including, but not exclusively, ink jet printing with conductive inks or rolling and laser printing using conductive inks and toners.

The step of embedding or encasing the terahertz image may involve encapsulating the image in an opaque material. The opaque material may comprise a ceramic or polymer based material.

The step of embedding or encasing the terahertz image may involve sandwiching the image between structural or protective layers to define a laminated structure. The main body layers may comprise paper and/or plastic and/or ceramic. Preferably, the paper and/or plastic and/or ceramic is opaque at visible wavelengths.

According to yet another aspect of the invention, there is provided a method for determining secure information on a security label and/or authenticating a security label, the method comprising: irradiating the label with terahertz radiation; detecting radiation either transmitted or reflected from the label; and using the radiation detected to determine any secure information contained in the label and/or the authenticity of the label.

This method is provided to identify information included in a terahertz image that is embedded within a security label and/or authenticate the label using that terahertz image. In the event that no image or an erroneous, spurious or false image is detected using the terahertz radiation, this provides an indication that the security label is not authentic.

According to yet further aspect of the invention, there is provided a system for determining secure information on a security label or authenticating a security label, the system comprising: a source for irradiating the label with terahertz radiation; a detector for detecting radiation either transmitted or reflected from the label; and means for using the detected radiation to determine the secure information contained in the label and/or the authenticity of the label.

Information may be embedded as (a) amplitude modifying (grey scale or black and white) or (b) phase modifying (diffractive optic or hologram). In the former case, the means for using the detected radiation are operable to use the amplitude of the detected signal to determine the information. In the latter case, the means for using the detected radiation are operable to use the phase of the detected radiation to determine the information.

### BRIEF DESCRIPTION OF THE DRAWINGS

Various aspects of the invention will now be described by way of example only and with reference to the accompanying drawings, of which:

FIG. 1 is a cross-section of a terahertz security label, in which is embedded a reflection mode terahertz image or tag;

FIG. 2 is a cross-section of a terahertz security label, in which is embedded a transmission mode terahertz image or tag;

FIG. 3 is a plot of depth versus frequency for a transmission mode and a reflection mode terahertz security label;

FIG. 4 is a plot of depth versus frequency for a security label that includes a multi-level grating;

FIGS. 5(a) to (d) show the steps taken to make a security label using a hot-embossing technique;

FIGS. 6(a) to (f) show the steps taken to make a security label using a multi-level etching process;

FIG. 7 is a cross-section through a security label that contains two holographic structures that are encapsulated in an opaque polymer;

FIG. 8 is a cross-section through a laminated security label that includes the label of FIG. 7;

FIG. 9 is a block diagram of an imaging system that can be used to image a terahertz security label;

FIG. 10 is a diagrammatic view of an image on a security label produced by the system of FIG. 10, and

FIG. 11 is a plan view of a terahertz image that comprises a fractal structure.

### DETAILED DESCRIPTION

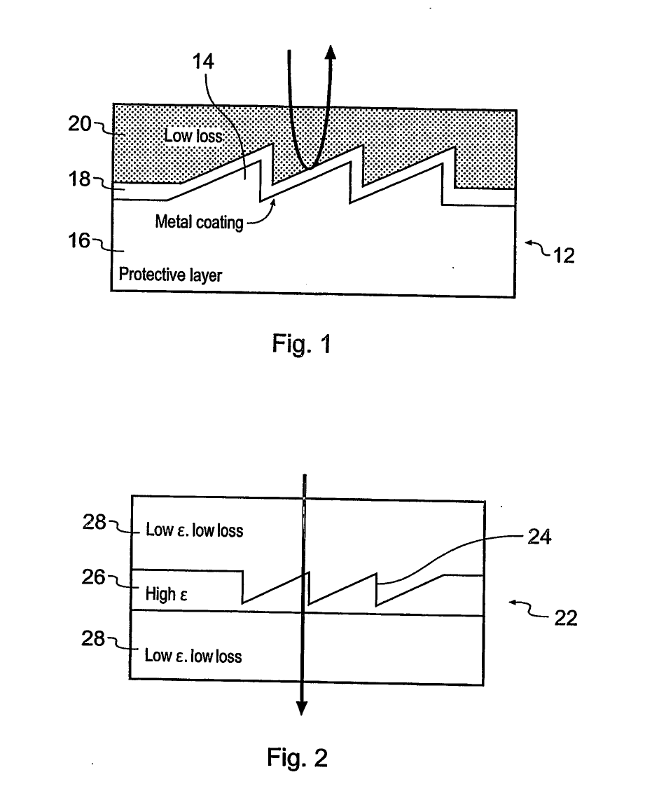

The security tag in which the invention is embodied has one or more terahertz structures, preferably holographic terahertz structures, hidden inside it. By terahertz, it is meant that the images can only be viewed using an imager that uses radiation in the range 25 GHz to 100 THz, preferably 100 GHz to 100 THz. By holographic, it is meant structures created in relief, i.e. having three dimensions. FIG. 1 shows an example of a suitable structure having a series of peaks 14 formed in a dielectric material 16, these peaks 14 being coated with metal 18 and embedded in a low loss material 20. In this particular example, the structure is adapted to act in a reflection mode. This will be discussed in more detail later.

The structure of FIG. 1 includes security information and is invisible to the unaided eye. However, when the label is viewed with a terahertz imaging system, radiation reflected from the metal-coated structures allows the security information to be clearly detectible. Of course, as will be appreciated, the security information is not seen directly by the naked eye, but is reproduced on the terahertz imaging system's display screen. A suitable imaging system will be described in more detail later.

In order to be detectable using a terahertz imaging system, the image embedded within the label has to have relief features that have one or more dimensions that can be detected using terahertz radiation. In practice, this means that the terahertz image has to be relatively thin. It should be noted that the actual thickness is related to the wavelength of the illuminating radiation. For example, a reflective mode hologram embedded in a polymer with a refractive index of 1.5 only needs to be 100□m thick for use at 1 THz, with individual relief features having a thickness that is the same or smaller than this. Some additional thickness is necessary to embed or laminate the image into a card or tag. The thin terahertz image or tag is embedded or defined within outer layers that protect it and provide the main body of the label. Because of its relative thinness, the terahertz image or tag is undetectable without terahertz imaging because no detectable reliefs appear on the surface of the medium in which it is hidden. Security can be further enhanced by ensuring that the material that covers the tag can block visible radiation. For example, the tag could be covered with paper or opaque plastic or any other such material that does not transmit light within the visible part of the electromagnetic spectrum, but is transparent to terahertz radiation. Preferably, the label with its embedded terahertz image and outer layers is flexible.

The security label with its terahertz tag may be designed to operate in either a transmission mode or a reflection mode.

By reflection mode it is meant that the terahertz tag is adapted to reflect radiation and the imaging system is operable to interpret that reflected radiation. As noted previously, the tag of FIG. 1 is a reflection-mode tag 12. In this case, a metal-coated grating 18 is embedded inside a low loss material 20. On the side that is not imaged, any other material may be used since the metal coating renders it invisible to the terahertz imaging system. In use, radiation from the imaging system is incident on the metal grating 18 and reflected therefrom. This reflected radiation is used to read the image.

By transmission mode it is meant that the terahertz tag transmits terahertz radiation and the imaging system is operable to interpret radiation that is transmitted through the tag. FIG. 2 shows a transmission-mode tag 22. In this case, a grating 24 defined in a high dielectric constant material 26 is embedded inside a low loss, low dielectric constant material 28. As will be appreciated, metal coatings cannot be used for transmission mode tags, because they do not transmit. A high dielectric contrast between the two materials 26 and 28 is desired. For example, silicon could be used to define the grating, because this has a high dielectric constant of approximately 12, compared to 2-3 for many polymers and glasses.

For both the reflection and transmission mode labels of FIGS. 1 and 2, the depths of the three dimensional features that form the tag have to be carefully defined in order that the images that are to be detected using terahertz radiation are meaningful. The maximum phase change required at any point in a holographic grating is less than 2π. Using this, the maximum useful depth d_{T} of a transmission-mode holographic grating may be calculated as a function of the material system and the incident wavelength to be: d_{T}=λ/(nₛ−nᵢ), where λ is the free-space wavelength of the incident terahertz rays, nᵢ is the refractive index of the incident medium and nₛ is the refractive index of the substrate.

For a reflection mode holographic grating, the maximum depth d_{R} is halved, and there is no dependence on nₛ if the reflection coating on the grating is deep enough to ensure that it behaves as a metal at the frequency in question, so that d_{R}=λ/2nᵢ. To fulfil this requirement, the coating should have a depth that is greater than approximately 4.6 skin depths, where skin depth δ=1/[√(πfμσ)] (metres), with f=frequency in hertz, μ=μᵣ×μ₀ is the permeability of the material in Henrys/metre (μ₀=4π×10⁻⁷ Hendrys/metre), σ is the conductivity of the material in Siemens/metre. Of course, thinner coatings could work, but this would be with a reduced efficiency.

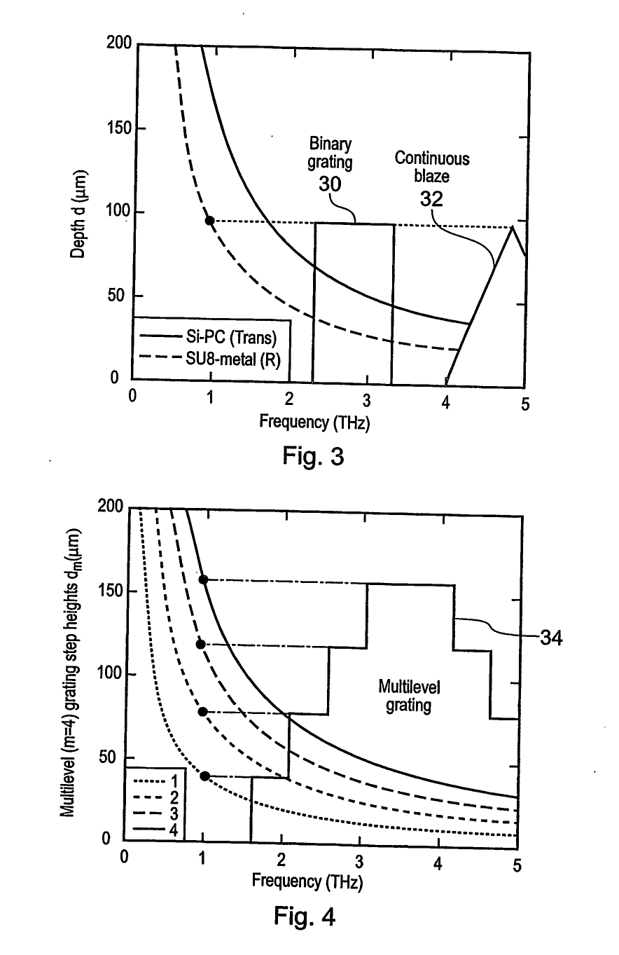

FIG. 3 shows a plot of the maximum depth that can be used versus frequency for (1) a terahertz image that is formed in silicon embedded in polycarbonate, operating in a transmission mode and (2) an SU-8 based pattern coated with metal, operating in a reflection mode. Examples of the profile of a binary 30 and continuous blaze grating 32 are also shown on this graph, with a depth suitable for operation at 1 THz. By blaze grating it is meant a pattern in the x-y plane of a structure that has a slope in the z-direction of the structure, providing a phase shift, which is continuously changing over the x-y plane in the region of the blaze. The use of blazed gratings provides the following advantages: (1) greater optical efficiency, and (2) elimination of high order diffractive order modes. The optical efficiency of a blazed grating is as follows: 2-level gives 41% of power in the first mode, 4-level gives 81% of power in the first mode, and 8-level gives 95% of power in the first mode. An 8-level grating is usually satisfactory for most applications. Of course, the number of levels needed is a matter of choice, and would depend on the nature and amount of information that is to be included in the image.

FIG. 4 is similar to FIG. 3, except in this case the plot shows the individual step heights for a multi-level transmission mode silicon grating embedded in polycarbonate and having M=4 levels. The y-axis is multilevel (M=4) grating step heights dₘ(μn). The x-axis frequency (THz). In this case, the depth of each step is given by: dₘ=d_{T}(m/M). The multi-level grating 34 of FIG. 4 is drawn with a depth suitable for operation at 1 THz.

The buried terahertz structure can be any recognisable pattern that is only visible to a terahertz imaging system operating either in reflection or transmission mode. Examples include the aforementioned holograms, but may include simple wires, punched foil or any other metallic or dielectric medium that can be patterned to provide an image forming amplitude and/or phase contrast. These images could be a hologram, a shadow pattern or a reflected pattern. The structure could be made from any suitable material such as polycarbonate, polymethylmethacrylate, polystyrene, epoxy, polyethylene, Teflon, nylon, polyvinylchloride, thermosetting resins of the alkoyd, phenolic, polyamide, polyanhydride, polyimide, polyurethane, resorcinol, silicone and urea types or any mouldable plastic capable of taking an imprint or embossment.

Terahertz images or structures may be replicated inexpensively using established techniques including, but not limited to hot embossing, either roll or press, injection moulding, UV casting, multi-level etching, or printing using a conductive ink.

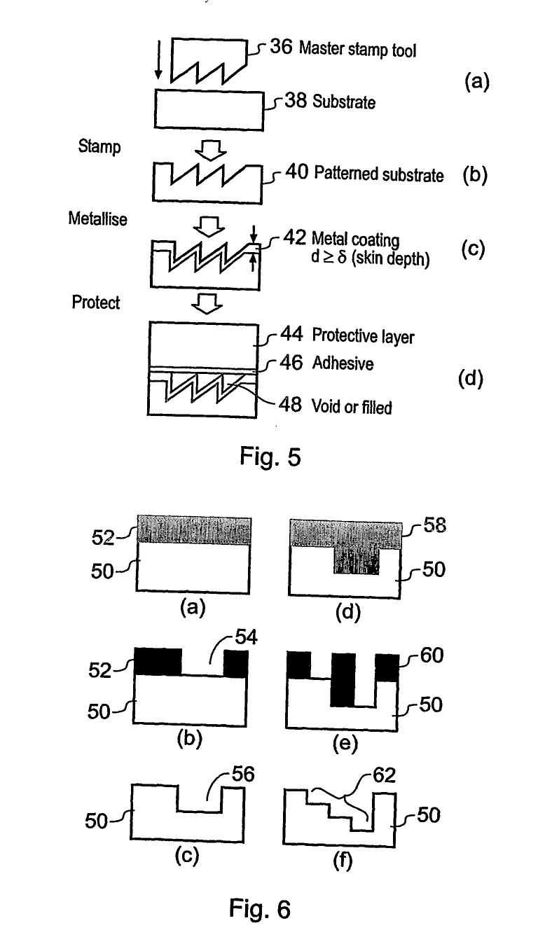

FIGS. 5(a) to (d) show the steps in a hot embossing process. In this, a master tool or stamp 36 is used to stamp a pattern in a heated substrate 38, which can be of any suitable dielectric material, as shown in FIG. 5(a). For durability, the master stamp 36 is preferably made of metal. The master stamp 36 can be formed using a number of different methods, including laser cutting, deep reactive ion etching (DRIE), wet chemical etching, and computer numerical controlled (CNC) conventional machine processes. After stamping, a patterned substrate 40 is defined, see FIG. 5(b). This substrate 40 is then coated with metal 42 that is thicker than the skin depth (as described previously) at the operating frequency of the terahertz imaging system, as shown in FIG. 5(c). A protective layer 44 is then attached to the metal side of the grating, preferably using an adhesive 46, see FIG. 5(d). The adhesive 46 should be such that it provides a bond that is stronger than the adhesion between the stamped substrate 40 and the metal coating 42. Optionally, the voids 48 between individual peaks of the grating may be left empty or in-filled with material that is transparent to terahertz radiation. The protective layer may be made of any suitable material that is opaque to visible light, and transparent to terahertz radiation, for example paper or plastic. The resulting label is flexible and able to bend like paper. However, attempts to disassemble the label for copying would result in the destruction of the information carrying pattern.

FIGS. 6(a) to (f) show the steps in a multi-level etching process for forming a four level phase shifting plate suitable for use in a transmission mode label. In a first step a suitable substrate 50, such as silicon, is coated with photo-resist 52, such as SU-8, see FIG. 6(a). The photo-resist 52 is then exposed and developed to open a slot or hole 54 in the resist through to the substrate 50, as shown in FIG. 6(b). The substrate 50 is then etched using the resist as a mask and the mask is subsequently removed. This leaves a slot 56 etched into the substrate 50 with a depth that is selected to achieve the required phase difference for the transmitted terahertz rays, see FIG. 6(c). The etch depth is controlled by the etch process.

Once the slot 56 is defined, a second layer of resist 58 is applied to the substrate and another photo-mask is used create a further mask 60 over the already etched surface, as shown in FIGS. 6(d) and (e). A second etch is then performed, thereby to define a three-dimensional stepped portion 62 of the substrate, as shown in FIG. 6(f). More specific details of a suitable etch process are provided in the article “Fabrication of Multi-level Silicon Diffractive Lenses for Terahertz Frequencies” by Walsby et al, 1999, SPIE Conference on Micro-machined Technology for Diffractive and Holographic Optics.

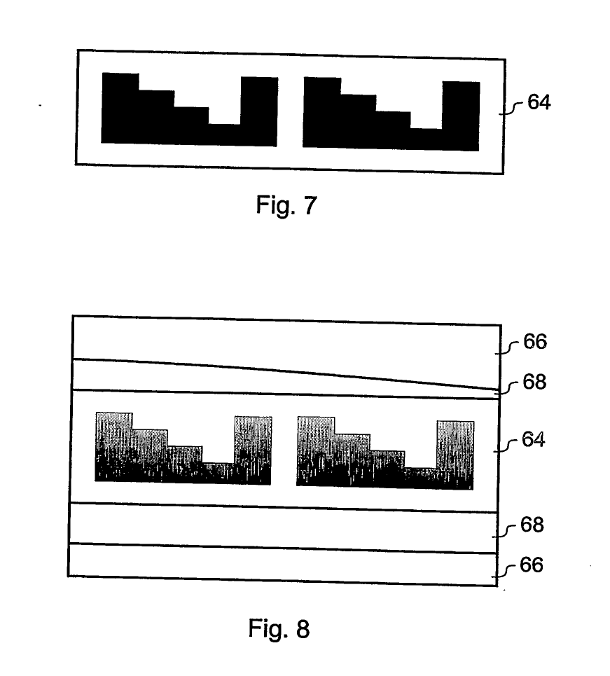

Once the relief patterns of FIGS. 5 and 6 are defined they may be embedded within further structure that is opaque to visible radiation but transparent for terahertz radiation. For example, FIG. 7 shows two terahertz images formed using the technique described with reference to FIG. 6 embedded or encapsulated within a polymer. This polymer should be such as to provide a further barrier to prevent the pattern being viewed by the unaided eye. In this way, the terahertz image is completely obscured from view. Alternatively or additionally, the terahertz images of FIGS. 5, 6 or 7 may be included in a laminated structure 65. An example of this is given in FIG. 8. The laminated structure 65 may include layers of paper 66 and/or plastic 68, which are preferably opaque to light in the visible part of the electromagnetic spectrum. In accordance with standard practice, the outer layers of the label may carry printed material. This can include plain text and/or encoded symbols such as bar codes and/or graphics.

When the holographic or other structure hidden inside the label is irradiated with terahertz radiation, it creates a distinct pattern of radiation, which can be detected by one or more sensors that may be scanned across the space to be imaged. The specific nature of the pattern is not restricted in any way, and thus it is possible to encode information, such as name and number, or even graphical pictures, or for example a watermark or such like.

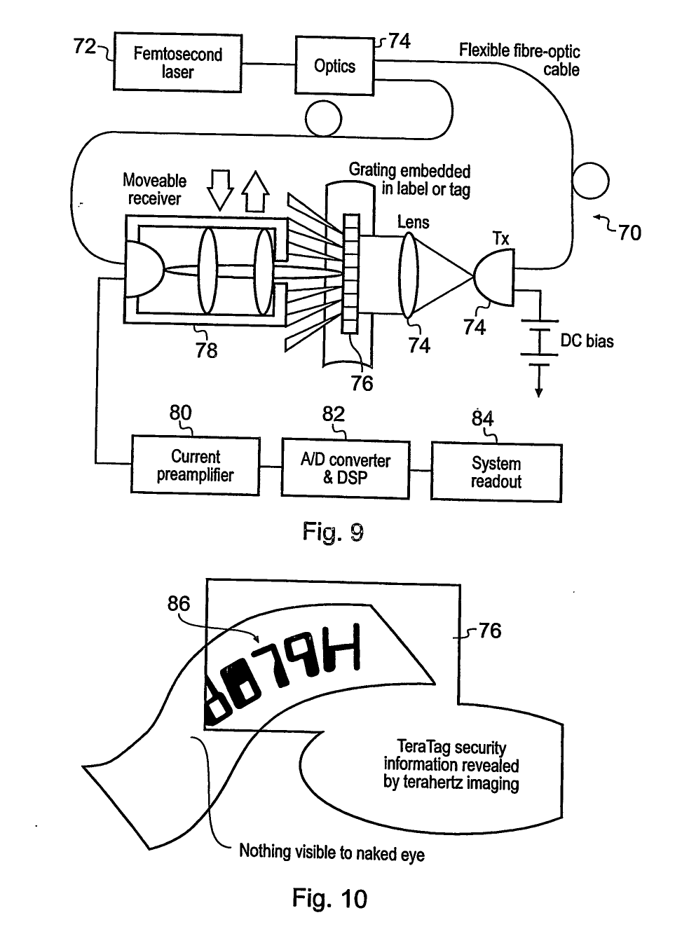

FIG. 9 shows an imaging system that can be used to image terahertz structures that are embedded within the labels. Terahertz imaging systems are currently available and can be bought, for example, from Picometrix. Hence, the imaging system itself will not be described in detail. The imaging system 70 of FIG. 9 includes a femtosecond laser 72, the output of which is passed through various optical components 74 in order to generate terahertz radiation and direct it onto a label 76 that is to be scanned. In the particular example shown in FIG. 9, the label 76 that is shown as being scanned is a transmission mode label, although a reflection mode label could equally be used.

Terahertz radiation transmitted through the label 76 is received at a movable detector 78. Ideally, in practice this would be a hand held detector 78. The detector 78 converts the received optical signal into an electrical signal. This is passed to a current amplifier 80, and then converted using an analogue to digital converter and digital signal processor (DSP) 82 into a suitable format for display on a readout system 84 that provides a user interface (not shown). The nature of the signal processing will of course depend on the nature of the output that is to be presented to the user. For example, the readout 84 may provide a direct representation of the image detected or may alternatively be adapted to merely provide an authentication signal indicative of whether the label is or is not authentic. In the latter case, the imaging system has to include means for using the detected radiation to determine whether the label is authentic.

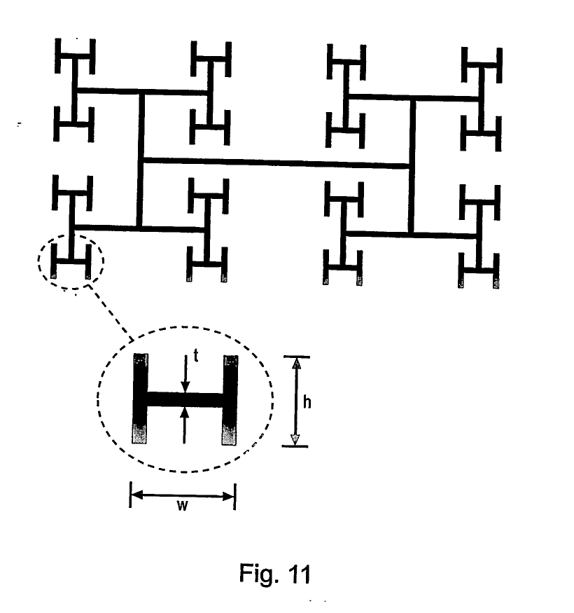

FIG. 10 shows an example of an image 86 displayed on the system readout 84 of FIG. 9. In this case, the image 86 provided by the readout system is plain text. This plain text is invisible to the unaided eye and can only be viewed using the terahertz imaging system. By scanning the label, there is provided a method for identifying secure information or authenticating the label.

Optionally, the information in the terahertz label may be encoded. In this case, rather than displaying the encoded version of the image, the imaging system may include a decoder for decoding the information and providing the decoded information to a user in a human readable format.

In the label in which the invention is embodied, a terahertz image is provided. In the examples described above, the terahertz image is a holographic structure. However as noted before, other structures could be used. As a specific example, fractal structures may be used. Details of these may be found in “Fractals Form, chance and dimensions” by B. B. Mandelbrot, 1977, ISBN 0-7167-0473-0. These can be patterned in a preferably planar layer of conductive material, such as conductive ink or metal foil, having unique spectral signatures containing multiple resonances. This type of tag may be read using a single short pulse such as that provided by existing terahertz systems, and taking a Fourier transform of the received signal to obtain the spectral response. As before, these types of labels may be adapted to be used in a transmission or reflection mode.

For fractal patterns, the spectral signature, i.e. the frequency of the resonances, of the tag is/are determined by the physical dimensions of the elements of that pattern. An example of this type of fractal pattern is the H-tree, as shown in FIG. 11. The physical dimensions of the H-tree fractal pattern are the width of the rod (t), the depth of the foil or ink in which it is patterned (d), the width (w) and height (h) of the basic pattern in the smallest level, the ratio of the width to height, and the size ratio between successive levels in the pattern. For the pattern of FIG. 11, the width is twice the height, and successive levels are twice the size of the previous level, going from small to large features.

An advantage of using fractal structures is that the spectral signature may vary with the rotation of the label, and the polarisation of the interrogating electromagnetic pulse. This provides additional difficulties for the counterfeiter. Of course, in some circumstances, this may not be desired. In such cases, polarisation and orientation invariance may be achieved by creating two layers of the pattern, one layer being rotated 90 degrees with respect to the other and separated by a thin dielectric spacer (not shown). For example, this could be achieved by printing on both sides of a piece of paper. A further advantage of using fractal patterns is that the conductive fractal pattern component of the tag need only have a thickness that is greater than 4.6 skin depths. This means that at 1 THz, a gold fractal pattern would need only to be approximately 100 nm thick, with additional thickness being provided by the outer layers of the tag as previously described. Of course, thinner layers may be used for the fractal pattern, but these would suffer from reduced efficiency.

A yet further advantage of a fractal structure is that the x-y dimensions of the pattern may be made smaller than the wavelengths of the interrogating radiation, allowing a more compact label to be produced. For example, at 100 GHz the free-space wavelength is 3 mm yet reflectivity may be obtained from a fractal pattern as small or smaller than 1 mm by 1 mm, whereas a solid metal pattern such as a counterfeiter might use, would not reflect nor would it have the distinct spectral signatures. For further details see L. Zhou, W. Wen, C. T. Chan and P. Sheng, “Reflectivity of planar metallic fractal patterns”, Applied Physics Letters, Vol. 82, Number 7, pages 1012-1014, 17 Feb. 2003.

The security label in which the invention is embodied can be used for many different applications. For example, it could be used as a means to authenticate documents, including banknotes, with a terahertz “watermark” sandwiched in paper or embossed into a plastic banknote. Alternatively the frequency-selective or fractal version of the tag could be integrated into the metallic ribbon device used in some existing banknotes. In some cases, for example banknotes, the opaque covering layer(s) may be omitted to suit production processes. While this leaves the pattern in full view it still provides a strong degree of protection against counterfeiting because a significant amount of effort would need to be expended in order to make a copy of the pattern. In such cases, the pattern may be integrated into the overall decorative aspects of the document or banknote, which may additionally conceal its role as a terahertz anti-counterfeiting pattern. Equally it could be used as a tag for a door-entry system, a label for packaging, in anti-counterfeiting measures, baggage tracking, or customs/excise security. In any case, it provides numerous advantages. For example, it can be used to securely store a significant amount of information without needing a microchip. This means that a relatively high level of security can be provided for a relatively low cost. A further advantage is that terahertz radiation is non-ionising. This is useful when the security labels are to be attached to, for example, foodstuffs or photographic equipment or other such sensitive goods, because it means that damage can be minimised or avoided during the scanning process. Also, since the terahertz tags embedded within the labels are very thin, they would be damaged in the event that an unauthorised party tried to expose the image by for example de-laminating the label. This in effect makes the labels tamper-proof.

A skilled person will appreciate that variations of the disclosed arrangements are possible without departing from the invention. For example, although a discrete label has been described, it will be appreciated that the label could form an integral part of another body, for example it may be an integral part of packaging. Accordingly, the above description of a specific embodiment is made by way of example only and not for the purposes of limitation. It will be clear to the skilled person that minor modifications may be made without significant changes to the operation described.

1. A security label or document that includes one of a terahertz image and tag.

2. A security label or document as claimed in claim 1, wherein the terahertz image comprises a hologram.

3. A security label or document as claimed in claim 1, wherein the terahertz image is sensitive to the wavelength of the illuminating radiation.

4. A security label or document as claimed in claim 1, wherein the terahertz image comprises a fractal structure.

5. A security label or document as claimed in claim 1, wherein the terahertz image comprises a frequency selective surface.

6. A security label or document as claimed in claim 1, wherein the terahertz image is adapted to transmit terahertz radiation.

7. A security label or document as claimed in claim 1 wherein the terahertz image is adapted to reflect terahertz radiation.

8. A security label or document as claimed in claim 1 wherein the label is laminated.

9. A security label or document as claimed in claim 8 wherein the terahertz image or tag is formed or defined in one of the layers of the label.

10. A security label or document as claimed in claim 9, wherein the layers of the label comprise at least one of paper, plastic and ceramic.

11. A security label or document as claimed in claim 1 wherein a plurality of terahertz images or tags are provided.

12. A security label as claimed in claim 1 wherein the terahertz image or tag is encapsulated or enclosed or laminated within a material that is transparent to terahertz radiation, but opaque to visible radiation.

13. A security label or document as claimed in claim 1 wherein the label is flexible.

14. A security label or document as claimed in claim 1 wherein the label is rigid.

15. A security label or document as claimed in claim 1, wherein the terahertz image is defined using at least one of wires, punched foil and any other metallic or dielectric medium that can be patterned to provide an image forming contrast.

16. A security label or document as claimed in claim 1, wherein the terahertz image is formed in any one of polycarbonate, polymethylmethacrylate, polystyrene, epoxy, polyethylene, Teflon, nylon, polyvinylchloride, polyaniline, poly (3,4ethylenedioxythiophene), alkyd resins, phenolic, polaymide, polyanhydride, polyimide, polyurethane, resorcinol, silicone and urea resins or any other mouldable plastic.

17. A method for making a security label or document comprising embedding or enclosing a terahertz image within a main body portion.

18. A method as claimed in claim 17, further involving forming the terahertz image.

19. A method as claimed in claim 18, wherein the step of forming the terahertz image is done using hot-embossing techniques or by etching.

20. A method as claimed in claim 17 wherein the step of embedding or closing the terahertz image involves encapsulating the image within an opaque material.

21. A method as claimed in claim 20, wherein the opaque material comprises a ceramic or polymer based material.

22. A method as claimed in claim 17, wherein the step of embedding or enclosing the terahertz image involves including the image in a laminated structure.

23. A method as claimed in claim 22, wherein the laminated structure comprises layers of at least on of paper, plastic and ceramic.

24. A method as claimed in claim 23, wherein said layers are opaque.

25. A security or authentication method for determining secure information on a security label or document and/or authenticating a security label or document, the method comprising: irradiating the label or document with terahertz radiation ; and detecting radiation either transmitted or reflected from the label or document, thereby to perform at least one of:
(i) determining secure information contained in the label; and
(ii) authenticating the label.

26. A method as claimed in claim 25 further involving decoding the secure information to provide it in a human readable or legible format.

27. A security or authentication system for determining secure information on a security label or authenticating a security label, the system comprising a source for irradiating the label with terahertz radiation; a detector for detecting radiation either transmitted or reflected from the label; and means for using the detected radiation to perform at least one of:
(i) determining secure information contained in the label; and
(ii) determining the authenticity of the label.
